(19) United States
(12) Patent Application Publication
(10) Pub. No.: US 2010/0050890 A1
(43) Pub. Date: Mar. 4, 2010

(54) Infinitely variable cutoff printing press

(75) Inventors: Michael Thomas Woroniak, Rochester, NH (US); Mark Bernard Dumais, Kennebunk, ME (US)

Correspondence Address: Davidson, Davidson & Kappel, LLC, 485 7th Avenue, 14th Floor, New York, NY, 10018, US

(73) Assignee: Goss International Americas, Inc., Durham, NH (US)

(21) Appl. No.: 12/231,023

(22) Filed: Aug. 28, 2008

(51) Int. Cl. B41F 5/18

(52) U.S. Cl. 101/177

(57) ABSTRACT

A variable cutoff printing press is provided. The printing press includes a plate cylinder including a first center axis, a plate take-up cylinder including a second center axis and a removable plate having a first length traveling around the plate cylinder and the plate take-up cylinder. The first center axis and the second center axis are separated by a center distance, the center distance being variable so the plate can be removed and replaced with a second plate having a second length. A method of variable cutoff printing is also provided.

The present invention relates generally to a printing press and more specifically to a variable cut off apparatus and method.

### BACKGROUND OF INVENTION

Variable cutoff presses are used by printers needing to produce products of multiple lengths. On a conventional offset press, only one cutoff may be provided for, as cutoff has commonly been determined by the circumference of plate and blanket cylinders. Variable cutoff presses devise ways to be able to change this circumference in the printing plate. Individual cylinders may be replaced with cylinders of different diameter in order to effect a cutoff change.

One current method involves using sleeves of different sizes and thicknesses over plate and blanket cylinders to perform a cutoff change, resulting in a “variable cutoff press.”

Another method involves using a cartridge-style arrangement with each cartridge including a blanket cylinder, plate cylinder, and impression cylinder. Cartridges are swapped out when a new cutoff is desired.

U.S. Pat. No. 5,950,536 discloses a variable cutoff offset press unit wherein a fixed cutoff press is adapted to a variable cutoff press while maintaining the size of the blanket cylinders. A plate cylinder sleeve has a variable outer diameter, whereby a length of an image to be printed is varied proportionally to a variable outer diameter while maintaining an outer diameter of the gapless blanket cylinder sleeve constant. The size of a plate cylinder is changed by using a sleeve mounted over the plate cylinder or adding packing under a plate to increase the diameter of the plate cylinder.

U.S. Pat. No. 6,205,921 discloses a continuous image transfer belt which is useable in a variable image size offset press system and which is adapted to permit the press to print a variety of different sized printed matter is provided. The belt is used in an offset printing system having the capability to print variable-sized images. The system includes a source of ink; at least one plate cylinder and a replaceable sleeve for the plate cylinder, and a printing plate which is adapted to receive ink from the ink source. The system also includes at least one blanket cylinder; the image transfer belt positioned to contact the printing plate in a nip formed between the plate and blanket cylinders; an image transfer belt tensioning system to register the image transfer belt to the blanket cylinder position in the area of desired image transfer; and an image belt cleaning station adapted to remove residual ink from the surface of the belt.

U.S. Pat. No. 7,066,088 discloses a variable cut-off offset press system and method of operation which utilizes a continuous image transfer belt. The offset printing system comprises at least two plate cylinders adapted to have thereon respective printing sleeves. Each of the printing sleeves is adapted to receive colored ink from a respective ink source. The system further comprises at least an impression cylinder, wherein the image transfer belt is positioned to contact each of the printing sleeves at respective nips formed between respective ones of the plate cylinders and the at least one impression cylinder.

### BRIEF SUMMARY OF THE INVENTION

A variable cutoff printing press is provided. The printing press includes a plate cylinder including a first center axis, a plate take-up cylinder including a second center axis and a removable plate having a first length traveling around the plate cylinder and the plate take-up cylinder. The first center axis and the second center axis are separated by a center distance, the center distance being variable so the plate can be removed and replaced with a second plate having a second length.

A variable cutoff printing press including a cylinder, a take-up cylinder, a removable image carrier traveling around the cylinder and the take-up cylinder and a side support supporting the cylinder and the take-up cylinder is also provided. The side support includes a slot or other mechanical provision allowing a distance between the cylinder and the take-up cylinder to be varied so that image carriers of different sizes can be travel around the cylinder and the take-up cylinder.

A method of variable cutoff printing is also provided. The method includes the steps of printing an image having a first cutoff length with an image carrier that is positioned on a cylinder and a take-up cylinder, removing the image carrier from the from the cylinder and take-up cylinder, varying the distance between the cylinder and the take-up cylinder, positioning a second image carrier on the cylinder and the take-up cylinder and printing an image having a second cutoff length with the second image carrier.

### BRIEF DESCRIPTION OF THE DRAWINGS

The present invention is described below by reference to the following drawings, in which:

FIG. 1 shows a schematic side view of a printing press according to an embodiment of the present invention;

FIG. 2 shows a schematic side view of a print press according to another embodiment of the present invention configured to print images of a maximum cutoff;

FIG. 3 shows the print press from FIG. 2 configured to print images of a minimum cutoff; and

FIG. 4 shows a schematic side view of a printing section according to an embodiment of the present invention.

### DETAILED DESCRIPTION

Replacing cartridges or individual cylinders can be expensive due to the additional printing equipment needed and the storage space that is required for equipment. A different set of printing cylinders for the whole press is required for every cutoff that will be run. Changeover times may be long due to the nature of changing out these large, cumbersome cartridges or cylinders.

Using sleeves of different sizes may require a more complicated inker arid dampener design due to the need to be able to adjust form rolls and to separate form rolls from multiple cylinder sizes. Sleeves become more expensive as thickness increases.

Bridge sleeves, or intermediate sleeves, have been introduced between a mandrel and a printing sleeve as an alternative to thick sleeves. Bridge sleeves may be more cost effective than thick sleeves, but more equipment and storage space may be required. The equipment may also becomes somewhat more complicated because a mechanism of separating the mandrel, bridge sleeve, and print sleeve must be provided, usually in the form of compressed air.

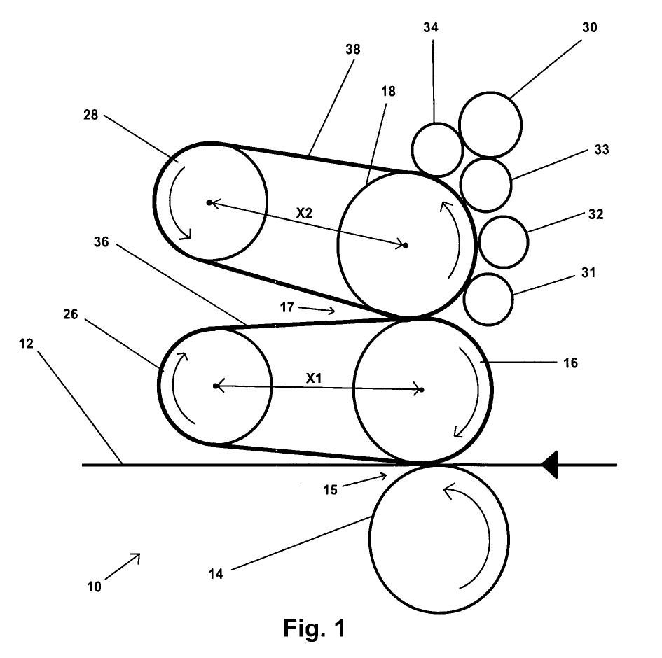

FIG. 1 shows a schematic side view of a printing press 10 according to an embodiment of the present invention. Printing press 10 includes an impression cylinder 14, a blanket cylinder 16, a blanket take-up cylinder 26, a plate cylinder 18 and a plate take-up cylinder 28. A blanket 36 is positioned on blanket cylinder 16 and blanket take-up cylinder 26 so that blanket 36 travels in a path around blanket cylinder 16 and blanket take-up cylinder 26 during printing. A plate 38 is positioned on plate cylinder 18 and plate take-up cylinder 28 so that plate travels in a path around plate cylinder 18 and plate take-up cylinder 28 during printing. Blanket 36 is of the same circumferential length as plate 38, which equals a cutoff length of images printed by printing press 10.

Ink and dampening solution are applied to plate 38 via rolls 30, 31, 32, 33, 34 as plate cylinder 18 and plate take-up cylinder 28 are rotated clockwise at the same tangential velocity. Plate 38 transfers an inked image to blanket 36 at a nip formed by plate cylinder 18 and blanket cylinder 16, as blanket cylinder 16 and blanket take-up cylinder 26 are rotated counterclockwise at the same tangential velocity as cylinders 18, 28. Blanket 36 prints an image having a cutoff length on a passing web 12 at a nip 15 formed between blanket cylinder 16 and impression cylinder 14.

Centers of blanket cylinder 16 and blanket take-up cylinder 26 are separated by a center distance X1 and centers of plate cylinder 18 and plate take-up cylinders 28 are separated by a center distance X2. In order to vary the cutoff length of images printing by printing press 10, center distances X1, X2 can be varied. Distances X1, X2 can be controlled by moving cylinders 26, 28 by linear actuators, eccentrics or other mechanisms. To vary the cutoff of images printed by printing press 10 cylinders 16, 18, 26, 28 do not need to be changed, but plate 38 and blanket 36 are replaced with plates and blankets having different lengths. In order to print images with a smaller cutoff distances X1, X2 may be decreased and in order to print images with a larger cutoff, distances X1, X2 are increased. Plates and blankets corresponding to the desired cutoffs are placed on cylinders 18, 28 and cylinders 16, 26, respectively, and distances X1, X2 are adjusted so plates and blankets have the proper tension.

Plate 38 and blanket 36 may be sleeve-like, i.e. continuous, or flat and attached to a continuous substrate.

In one embodiment of the present invention printing press 10 may be a perfecting printing press printing on both sides of web 12 printing in the same manner as printing press 10 with impression cylinder 14 being replaced by a second blanket cylinder, a second take-up blanket cylinder, a second blanket, a second plate cylinder, a second take-up plate cylinder and a second plate.

In another embodiment of the present invention a four color printing press can include four printing units, each printing in the same manner as printing press 10. The four color printing press can also be a perfecting printing press.

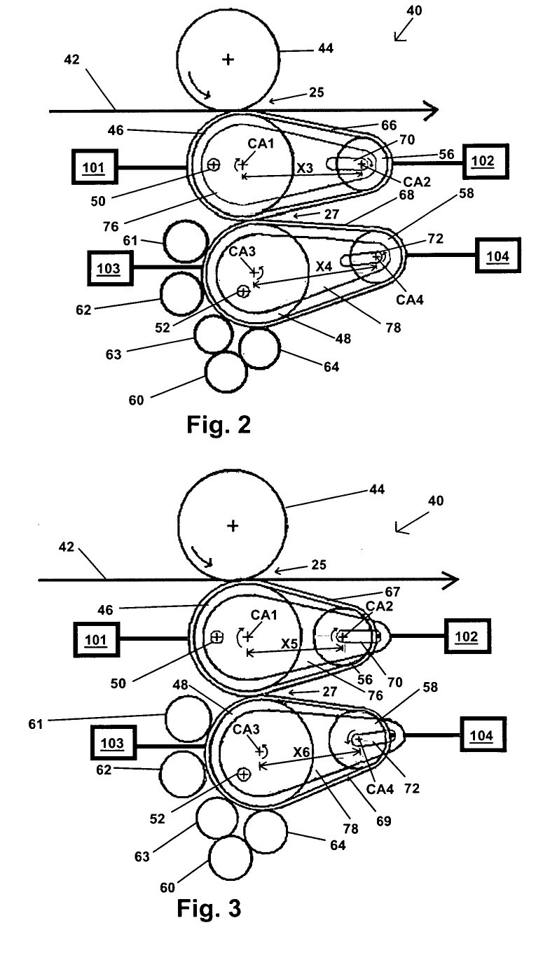

FIGS. 2 and 3 show schematic side views of a printing press 40 according to an embodiment of the present inventions for two different image cutoff lengths. FIG. 2 shows print press 40 configured to print images of a maximum cutoff and FIG. 3 shows print press 40 configured to print images of a minimum cutoff. Printing press 40 includes an impression cylinder 44, a blanket cylinder 46, a blanket take-up cylinder 56, a plate cylinder 48 and a plate take-up cylinder 58. Blanket cylinder 46 and take-up cylinder 56 are connected to and supported by a first pivoting side support 76, and plate cylinder 48 and plate take-up cylinder 58 are connected to and supported by a second pivoting side support 78. Side supports 76, 78 provide support for cylinders 46, 56, 48, 58 and include slots 70, 72, respectively.

A first slot 70 in side support 76, extending radially in relation to blanket cylinder 46, allows adjustment of a distance between a center axis CA1 of blanket cylinder 46 and a center axis CA2 of blanket take-up cylinder 56. A second slot 72 in side support 78, extending radially in relation to plate cylinder 48, allows adjustment of a distance between a center axis CA3 of plate cylinder 48 and a center axis CA4 of plate take-up cylinder 58. Blanket take-up cylinder 56 may include a pin, or other connecting mechanism, that axially extends from blanket take-up cylinder 56 at center axis CA2 and slides radially within first slot 70 to allow cylinders 46, 56 to accommodate printing blankets of different sizes. Plate take-up cylinder 58 may also include a pin, or other connecting mechanism, that axially extends from plate take-up cylinder 58 at center axis CA4 and slides radially within second slot 72 to allow cylinders 48, 58 to accommodate plates of different sizes. Locking mechanisms to fix take-up cylinders 56, 58 at desired points within slots 70, 72, respectively, may also be provided.

FIG. 2 shows blanket take-up cylinder 56 slid radially as far as possible away from blanket cylinder 46 in slot 70 and center axes CA1, CA2 are separated by a maximum distance X3 allowed by side support 76. Plate take-up cylinder 58 is also shown slid radially as far as possible to plate cylinder 48 in slot 72 and center axes CA3, CA4 are separated by a maximum distance X4 allowed by side support 78. A blanket 66 is positioned on cylinders 46, 56 so that blanket 66 travels in a path around cylinders 46, 56 during printing. A plate 68 is positioned on cylinders 48, 58 so that plate 68 travels in a path around cylinders 48, 58 during printing. Because blanket cylinder 46 and blanket take-up cylinder 56 are separated by a maximum distance X3 and plate cylinder 48 and plate take-up cylinder 58 are separated by a maximum distance X4, blanket 66 and plate 68 each have a printing surface length that equals the maximum cutoff length of images that can be printed by printing press 40.

Ink and dampening solution are provided to plate 68 by rolls 60, 61, 62, 63, 64. Plate 68 transfers images having a maximum cutoff length to blanket 66 at a nip 27 between plate cylinder 48 and blanket cylinder 46. Blanket 66 prints the images on web 42 at a nip 25 between impression cylinder 44 and blanket cylinder 46, as web 42 passes through a nip formed by blanket 66 and impression cylinder 44.

FIG. 3 shows blanket take-up cylinder 56 slid radially as close as possible to blanket cylinder 46 in slot 70 and center axes CA1, CA2 are separated by a minimum distance X5 allowed by side support 76. Plate take-up cylinder 58 is also shown slid radially as close as possible to plate cylinder 48 in slot 72 and center axes CA3, CA4 are separated by a minimum distance X6 allowed by side support 78. Because blanket cylinder 46 and blanket take-up cylinder 56 are separated by a minimum distance X5 and plate cylinder 48 and plate take-up cylinder 58 are separated by a minimum distance X6, blanket 67 and plate 69 each have a printing surface length that equals the minimum cutoff length of images that can be printed by printing press 40.

Ink and dampening solution are provided to plate 69 by rolls 60, 61, 62, 63, 64, which are configured the same in FIGS. 2 and 3. Because plate cylinder 48 may maintain the same spatial relationship with rolls 60, 61, 62, 63, 64, form rolls 61, 62, 63, 64 do not need to be adjusted with each change in cutoff. Plate 69 transfers images having a maximum cutoff length to blanket 67 at nip 27. Blanket 67 prints the images on web 42 at nip 25, as web 42 passes through a nip formed by blanket 67 and impression cylinder 44.

For printing press 40, take-up cylinders 56, 58 can be adjusted within respective slots 70, 72 of respective side supports 76, 78, to print images having a cutoff length anywhere in between the minimum cutoff length of the images printed by plate 68 and blanket 66 shown in FIG. 2 and the maximum cutoff length of the images printed by plate 69 and blanket 67 shown in FIG. 3. Cutoff can be changed by simply adjusting the distance between CA1 and CA2 and the distance between CA3 and CA4, by sliding take-up cylinders 56, 58 radially away from or towards cylinders 46, 48 in slots 70, 72, respectively. Different blankets and plates are provided for each cutoff.

Side supports 76, 78 may include respective pivots 50, 52. Blanket and plate cylinders 46, 48 may be actuated rotationally about pivots 50, 52 to create a separation between cylinders 44, 46, 48 for normal lithographic, setup and maintenance reasons, while maintaining the desired center distances between center axes CA1, CA2 and center axes CA3, CA4. Blankets 66, 67 and plates 68, 69 may be brought in and out of contact as cylinders 46, 48 are actuated rotationally about pivots 50, 52.

During printing, blanket cylinder 46 and blanket take-up cylinder 56 are rotated clockwise about respective axes CA1, CA2 by motors 101, 102, respectively, and plate cylinder 48 and plate take-up cylinder 58 are rotated counterclockwise about respective axes CA3, CA4 by motors 103, 104, respectively. In another embodiments, blanket and plate cylinders 46, 48 may be rotated by a first common motor and blanket and plate take-up cylinders 56, 58 may be rotated by a second common motor or cylinders 46, 48, 56, 58 may be rotated by a common motor.

Side supports 76, 78 could be replaced with side supports of different sizes or with different sized slots in order to increase center distances to be greater than distances X3, X4 and to decrease center distances to be less than distances X5, X6. Other mechanisms may be used to vary the distance between axes CA1, CA2 and the distance between CA3, CA4, such as sliding the take-up cylinders in rails or rotating the centers of the take-up cylinders in eccentrics.

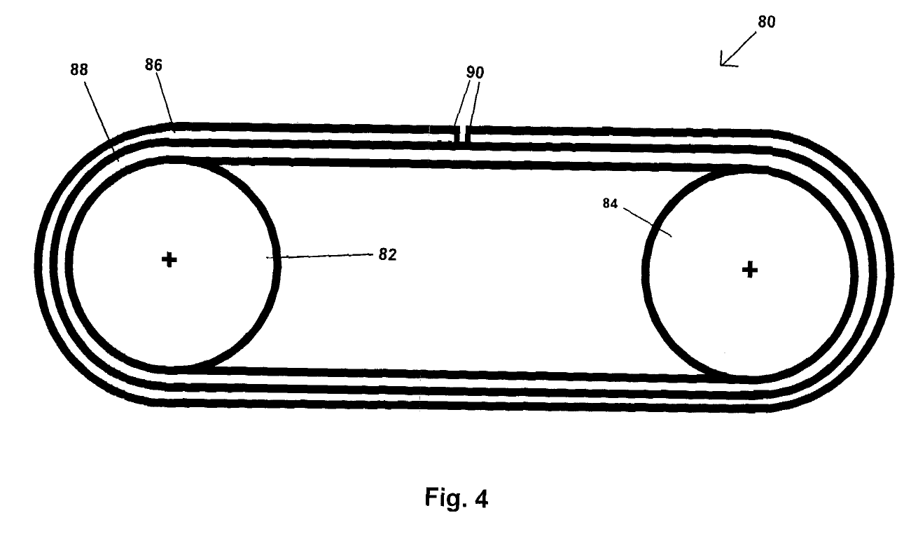

FIG. 4 shows a schematic side view of a printing section 80 according to an embodiment of the present invention. Printing section 80 includes a cylinder 82, a take-up cylinder 84, an image carrier 86 and a substrate 88. Cylinder 82 may be a plate or blanket cylinder, take-up cylinder 84 may be a plate or blanket take-up cylinder and image carrier 86 may be a plate or a blanket. Substrate 88 is wrapped around cylinder 82 and take-up cylinder 84 and may serve as a bonding surface or provide a mechanical lockup for installation of image carrier 86, when image carrier 86 is a flat plate or blanket.

In a preferred embodiment, a polyester-based printing plate may be bound to substrate 88 using an adhesive. Ends of substrate 88 may be joined together using heat, adhesives or mechanical mechanism.

It may be advantageous to minimize the discontinuity between ends 90 of image carrier 86 to avoid print defects due to vibrations that may result when ends 90 pass between nips of cylinders during printing. Ends 90 may also be spliced together with or without the use of substrate 88. Image carrier 86 may also be continuous.

The present invention may be used in flexographic presses as well as lithographic web offset printing presses by eliminating blankets and associated cylinders and providing plates with raised, negative image plates that transfer ink directly to the web.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A variable cutoff printing press comprising:
a plate cylinder including a first center axis;
a plate take-up cylinder including a second center axis; and
a removable plate having a first length traveling around the plate cylinder and the plate take-up cylinder;
the first center axis and the second center axis separated by a center distance, the center distance being variable so the plate can be removed and replaced with a second plate having a second length.

2. The variable cutoff printing press recited in claim 1 further comprising a blanket on a blanket cylinder contacting the plate.

3. The variable cutoff printing press recited in claim 1 further comprising:
a blanket cylinder including a third center axis;
a blanket take-up cylinder including a fourth axis; and
a removable blanket having a third length traveling around the blanket cylinder and the blanket take-up cylinder;
the third axis and the fourth axis separated by a second center distance, the second center distance being variable so the blanket can be removed and replaced with a second blanket having a fourth length.

4. The variable cutoff printing press recited in claim 3 further comprising an impression cylinder, the blanket receiving images from the plate and printing the images on a web, the web passing through a nip between the blanket and the impression cylinder.

5. The variable cutoff printing press recited in claim 1 further comprising a continuous substrate traveling around the plate cylinder and the plate take-up cylinder, the substrate supporting the plate, the plate being a flat plate.

6. A variable cutoff printing press comprising:
a cylinder;
a take-up cylinder;
a removable image carrier traveling around the cylinder and the take-up cylinder; and
a side support supporting the cylinder and the take-up cylinder, the side support including a slot allowing a distance between the cylinder and the take-up cylinder to be varied so that image carriers of different sizes can travel around the cylinder and the take-up cylinder.

7. The variable cutoff printing press recited in claim 6 wherein the image carrier is a printing plate.

8. The variable cutoff printing press recited in claim 6 wherein the image carrier is a printing blanket.

9. The variable cutoff printing press recited in claim 6 wherein the take-up cylinder includes a pin that slides radially in the slot.

10. The variable cutoff printing press recited in claim 6 wherein the side support includes a pivot and the cylinder may be actuated rotationally about the pivot.

11. The variable cutoff printing press recited in claim 6 further comprising a substrate wrapped around the cylinder and take-up cylinder, the substrate supporting the image carrier.

12. The variable cutoff printing press recited in claim 11 wherein the substrate serves as a bonding surface or provides a mechanical lockup for installation of the image carrier around the cylinder and take-up cylinder.

13. The variable cutoff printing press recited in claim 6 further comprising:
a second cylinder;
a second take-up cylinder;
a second removable image carrier traveling around the second cylinder and the second take-up cylinder; and
a second side support supporting the cylinder and the take-up cylinder, the second side support including a second slot allowing a second distance between the second cylinder and the second take-up cylinder to be varied so that second image carriers of different sizes can travel around the second cylinder and the second take-up cylinder;
wherein the image carrier can transfer images to the second image carrier.

14. The variable cutoff printing press recited in claim 13 wherein the side support includes a pivot and the second side support includes a second pivot, the cylinder being actuated rotationally about the pivot and the second cylinder being actuated rotationally about the second pivot so that the image carrier and the second image carrier are brought in and out of contact with each other.

15. A method of variable cutoff printing comprising the steps of:
printing an image having a first cutoff length with an image carrier that is positioned on a cylinder and a take-up cylinder;
removing the image carrier from the from the cylinder and take-up cylinder;
varying the distance between the cylinder and the take-up cylinder;
positioning a second image carrier on the cylinder and the take-up cylinder; and
printing an image having a second cutoff length with the second image carrier.
